(19) United States
(12) Patent Application Publication
(10) Pub. No.: US 2026/0119774 A1
(43) Pub. Date: Apr. 30, 2026

(54) Method for Transistor Layout Design Checking Using Reinforcement Learning

(71) Applicant: GenChip.AI Inc., Sunnyvale, CA (US)

(72) Inventors: Sreekar Bathula, San Jose, CA (US); Eric Panning, Portland, OR (US)

(21) Appl. No.: 19/376,689

(22) Filed: Oct. 31, 2025

Related U.S. Application Data
(60) Provisional application No. 63/714,796, filed on Oct. 31, 2024.
(60) Provisional application No. 63/714,754, filed on Oct. 31, 2024.
(60) Provisional application No. 63/714,761, filed on Oct. 31, 2024.
(60) Provisional application No. 63/714,793, filed on Oct. 31, 2024.
(60) Provisional application No. 63/714,797, filed on Oct. 31, 2024.
(60) Provisional application No. 63/714,773, filed on Oct. 31, 2024.

(51) Int. Cl. G06F 30/394; G06F 30/398; G06F 111/04; G06F 111/10; G06F 111/20; G06F 117/12; G06F 119/06

(52) U.S. Cl. CPC G06F 30/394; G06F 30/398; G06F 2111/04; G06F 2111/10; G06F 2111/20; G06F 2117/12; G06F 2119/06

(57) ABSTRACT

A method for automating semiconductor design involves receiving a netlist of an integrated circuit, generating a candidate layout using a permutation generator, and creating embeddings from the layout with a first machine learning model. The method includes generating parasitic extraction data values using a second machine learning model, comparing these values against predetermined design rule constraints to identify a design rule constraint score, and assigning a reward based on this score. The reward is transmitted to a reinforcement learning agent that modifies the permutation generator. The system outputs the candidate layout, parasitic extraction data, and design rule constraint score to a memory store.

### CROSS-REFERENCE TO RELATED APPLICATIONS

This application claims the benefit of and priority to U.S. Provisional Patent Application Ser. No. 63/714,754 entitled “Method for Estimating Parasitic Capacitance Using Spatial Localization,” 63/714,761 entitled “Method and System for Estimating Parasitic Capacitance Using Localized Weighting and Federated Learning Model,” 63/714,793 entitled “Method for Transistor Order Placement Using Graph Neural Network Recursive Model,” 63/714,797 entitled “Method for Transistor Layout Generation Using Graph Neural Network Recursive Model,” 63/714,796 entitled “Method for Transistor Layout Design Checking Using Reinforcement Learning,” and 63/714,773 entitled “Method For Transistor Layout Design Using 3D Model Representation in Latent Space,” all of which were filed on Oct. 31, 2024 and which applications are expressly incorporated herein by reference in their entirety.

### BACKGROUND OF THE INVENTION

The present disclosure generally relates to electronic design automation for the design and manufacture of integrated circuits and microelectronics.

Electronic design automation (EDA) includes software tools for designing electronic systems such as integrated circuits. With semiconductor chips having billions of components or more, computer-aided tools are essential for logical design, physical design, and manufacturing processes. Integrated circuit design includes many steps, typically beginning with a system specification. After system specification, several logical design steps can be completed based on that specification including register transfer level design, functional verification, timing simulation, and netlist generation. After logical design, physical design steps can be executed to generate a physical layout of the integrated circuit. There are many physical design steps including partitioning, floor planning, placement, clock tree synthesis, and signal routing, among others. After a physical layout is verified, then an integrated circuit can be fabricated using the physical layout generated from EDA tools.

EDA tools are helpful to optimize the production process for semiconductor devices, such as integrated circuits. Such optimization involves designing semiconductor layouts and evaluating properties of the designs. Important properties assessed include resistance and capacitance, which are instrumental in deriving estimates for Power, Performance, Area, and Cost (PPAC) of a semiconductor device. The accurate estimation of these properties can significantly influence cost savings. Various tools are employed in this process to perform detailed 3D assessments of the designs, enabling precise point-to-point calculations of resistance and capacitance. During the physical design process of an integrated circuit, a significant variable to generating an acceptable design that meets logical constraints and system specifications is parasitic capacitance. Parasitic capacitance is the unwanted, yet unavoidable, capacitance that exists between conductive parts of an electronic circuit. Parasitic capacitance can cause the behavior of chip components to depart from ideal performance. The calculation of resistance and capacitance thus plays an important role in determining power and performance values.

Physical layout design for integrated circuits is often complicated, challenging, and time consuming. A given logical design can identify the logical circuits and transistors to be included in a particular design, but then identifying a physical placement layout of transistors—that meets device specifications—is challenging because of the millions or more different layouts possible, each with respective advantages and disadvantages.

### SUMMARY OF THE INVENTION

Maintaining continuous, accurate, and precise operation of semiconductor manufacturing tools is essential for maximizing device yield. These tools, however, often require extensive development and processing time due to the rigorous calculations needed to ensure devices are manufactured correctly. These calculations provide important feedback for refining initial device designs. Delays and yield losses can significantly decrease productivity and increase the depreciation costs of processing tools. Furthermore, these tools can impact the productivity of engineers and limit opportunities for optimizing designs.

Conventional tools that perform parasitic extraction (PEX) calculations take an initial layout as input, actuate the process to create the complete semiconductor device, and then calculate the resistance and capacitance values based on the process and design. These calculations are then analyzed to correct the layout. This iterative process continues until a desired value set is achieved. This iterative process is very time consuming, which can add significant costs and/or delays to circuit design.

Techniques herein provide methods and systems to improve electronic design accuracy and time. Techniques herein include methods of generating transistor layout in a physical design, or improving layout of a physical design, to best meet design specifications by using by using a 3D model representation in latent space. Embodiments include generation of all possible layout models using permutations of placements that satisfy constraints of DRC (design rule check). These layouts are used as ground truth of a model configured to generate embeddings of the model and the same embeddings are used to generate the capacitance resistance values corresponding to the given embedding. These two models combined can be used as a reward function in a learning agent to determine a possible layout that has the best PPAC values (or optimized values or values meeting a threshold).

One general aspect includes a method for automating semiconductor design. The method also includes receiving a netlist of a very large-scale integration (VLSI) integrated circuit from an electronic design automation tool, the netlist including a description of electronic components and electrical connectivity. The method also includes generating, by a processing device, a candidate layout, the candidate layout including placed routes for placed standard cells, where a permutation generator is used to generate the candidate layout. The method also includes generating, by the processing device, embeddings from the candidate layout using a first machine learning model that includes an encoder-decoder. The method also includes generating, by the processing device, parasitic extraction data values from the candidate layout using a second machine learning model that evaluates the generated embeddings. The method also includes comparing parasitic extraction data values of the candidate layout against predetermined design rule constraints corresponding to the netlist to identify a design rule constraint score for the candidate layout, the design rule constraint score indicating comparative closeness of a given candidate layout to the predetermined design rule constraints. The method also includes assigning a reward based on design rule constraint score. The method also includes transmitting, by the processing device, the reward to a reinforcement learning agent that modifies the permutation generator based on the reward and corresponding candidate layout. The method also includes outputting, by the processing device, the candidate layout as a GDS file, corresponding parasitic extraction data, and design rule constraint score to a memory store. Other embodiments of this aspect include corresponding computer systems, apparatus, and computer programs recorded on one or more computer storage devices, each configured to perform the actions of the methods.

### BRIEF DESCRIPTION OF DRAWINGS

This disclosure will be understood more fully from the detailed description below and from the accompanying figures of embodiments of the disclosure. The figures are used to facilitate understanding of embodiments of the disclosure and do not limit the scope of the disclosure to these specific embodiments. The figures are not necessarily drawn to scale.

FIG. 1 is a flow diagram of systems herein for layout design checking.

FIG. 2 is a flow diagram of methods herein for reinforcement learning for layout design checking.

FIG. 3 is a diagram of example subsystems used herein.

FIG. 4 is a diagram showing an architecture of techniques herein.

FIG. 5 is a conceptual representation of conversion techniques herein.

FIG. 6 is a flow chart of example methods disclosed herein.

FIG. 7 depicts a representative diagram of an example computer system in which embodiments of the present disclosure may operate.

### DETAILED DESCRIPTION

Techniques herein include methods of placing transistors in a physical design to best meet design specifications by using a network trained to extract the capacitance and resistance values of generated layouts. This network may include a machine learning model, such as a random forest regressor or graph neural network, trained on layout data to predict parasitic parameters based on geometric and topological features. Techniques also include a reinforcement learning engine using a reward system to continuously improve a layout generator to generate layouts that better meet design rule constraints. The reward system evaluates layout quality based on compliance with design rules and predicted electrical performance, guiding the reinforcement learning agent to iteratively refine placement and routing strategies.

Accordingly, techniques herein address persistent challenges of automating standard cell layout design in advanced technology nodes. Conventional methods struggle with the increasing complexity and volume of design rules, making efficient and rule-compliant layout generation difficult. Design rule constraints may include spacing, width, enclosure, and density rules defined by process design kits (PDKs), which are increasingly difficult to satisfy manually or with traditional rule-based tools.

Embodiments herein, however, use reinforcement learning (RL) techniques to automate the layout generation process, particularly focusing on device placement and routing while adhering to design rule constraints.

Embodiments herein use reinforcement learning to handle design rule violations during the routing process and optimize device placements using a PPAC model trained on layouts generated by a permutation engine. The PPAC model (Power, Performance, Area, and Capacitance) evaluates layout quality across multiple metrics, enabling the RL agent to balance trade-offs during optimization.

This RL-based approach learns to fix design rule violations iteratively through rewards given by the environment/system. The environment provides feedback based on rule violations and parasitic estimates, allowing the agent to adjust its policy to minimize violations and improve layout quality over time. The routing problem can be decomposed into initial routing and design rule checking (DRC) fixing, with the reinforcement learning agent trained to resolve DRC issues in the initial routes and get a best design or a design having a closest adherence to the design rules, or a design within a specified tolerance of the design rules. This decomposition allows the RL agent to focus on localized corrections, improving convergence and scalability of the learning process.

For the process of training models, a model herein generates possible layouts of a given standard cell(s) using a permutation generator engine. The permutation generator systematically explores different spatial configurations of transistor placements and routing paths, producing a diverse set of candidate layouts.

Thus, the candidate layouts generated can be a relatively large set of candidates. This permutation generator engine can make a brute force calculation of all the placements and write a layout that follows all the design rules. Although brute-force in nature, the generator may apply heuristics to prune infeasible or redundant configurations, improving efficiency. The design rules are the general measurement rules that specify the width and spacing of the layers for a given technology, such as a particular process design kit. These rules are typically defined by foundries and are critical for ensuring manufacturability and reliability of the final chip. Selection of these standard cells is based on a clustering algorithm that can represent all the standard cells. The clustering algorithm groups similar cells based on structural or functional characteristics, enabling representative sampling for training and evaluation. The learning can be easily transferred to the space of larger composite cells containing multiple cells or electronic components. This transferability allows the trained models to generalize from simple cells to more complex hierarchical designs. This layout data is converted to 2D image-based data. By way of a non-limiting example embodiment, a size of 64×64×(number of layers) can be used for this image-based step. Each layer in the layout is mapped to a separate channel in the image, preserving layer-specific information for machine learning models. This layout, or each layout, can be sent to an encoder-decoder based machine learning model to generate the embeddings of the layout. The encoder compresses the layout into a latent vector capturing spatial and structural features, while the decoder reconstructs the layout to validate information retention. These embeddings are then sent to another (separate) model that is configured to predict or estimate overall resistance and capacitance of the semiconductor device (which can be seen in loops from subsequent figures). The second ML model, or model for extracting resistance/capacitance values can be that described in U.S. patent application Ser. No. 19/376,591 titled Method for Parasitic Extraction Using Spatial Localization filed concurrently herewith, the contents of which are incorporated herein by reference in their entirety. This model can extract resistance/capacitance values within seconds using inference-based modelling, with very high accuracy (for example 99% accuracy) to quickly obtain PPAC values that would otherwise take hours, days, or weeks.

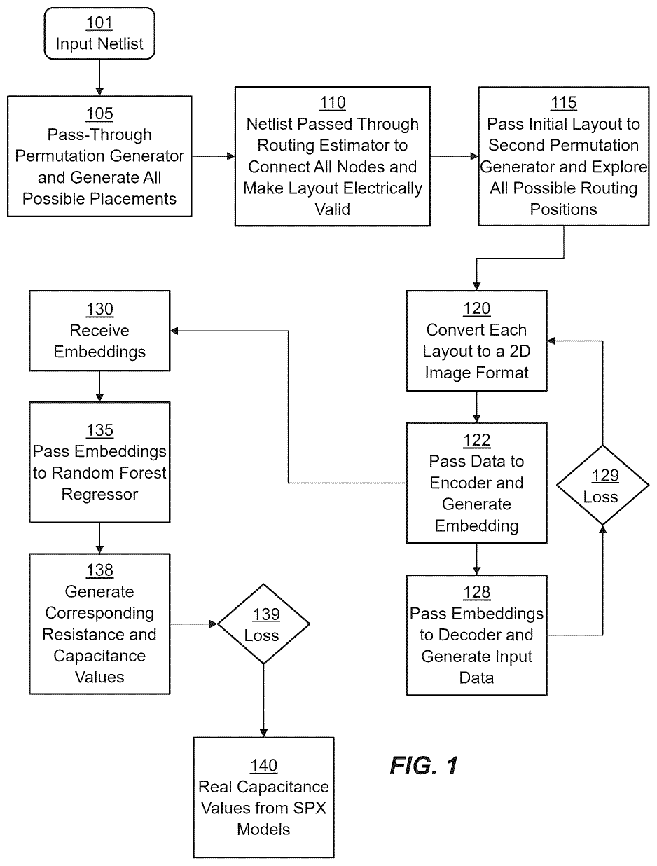

FIG. 1 shows a flow diagram of a method for transistor layout design checking using reinforcement learning. The process begins with an input netlist 101, or other input that includes a logical design of an integrated circuit. This input can include descriptions of electronic components and their electrical connectivity. In step 105, the system passes the netlist through a permutation generator to generate all possible placements of the transistors. The permutation generator is a computational module that systematically explores different spatial arrangements of transistors based on the logical connectivity defined in the netlist. It uses combinatorial algorithms to enumerate feasible placements, considering constraints such as cell adjacency, symmetry, and layout area. This step ensures that all potential or candidate configurations, or a plurality thereof, are considered for further evaluation. Having a significantly large pool of candidates increases the probability of finding a best or optimized layout.

In step 110, the netlist is passed through a routing estimator to connect all nodes and make the layout electrically valid. The routing estimator is a heuristic or rule-based engine that simulates interconnect paths between transistor terminals, ensuring that the electrical connections specified in the netlist are physically realizable. It estimates wire lengths, via placements, and layer usage to validate connectivity. This step ensures that the generated placements are feasible from an electrical connectivity standpoint. Step 115 involves passing the initial layout to a second permutation generator to explore all possible routing positions. This second permutation generator focuses on routing permutations rather than transistor placements. It generates alternative routing topologies by varying wire paths, layer assignments, and via configurations, thereby expanding the design space to include multiple routing solutions for each transistor layout. This step further refines the layout by considering different routing possibilities to have a large pool of both transistor layouts and routing possibilities.

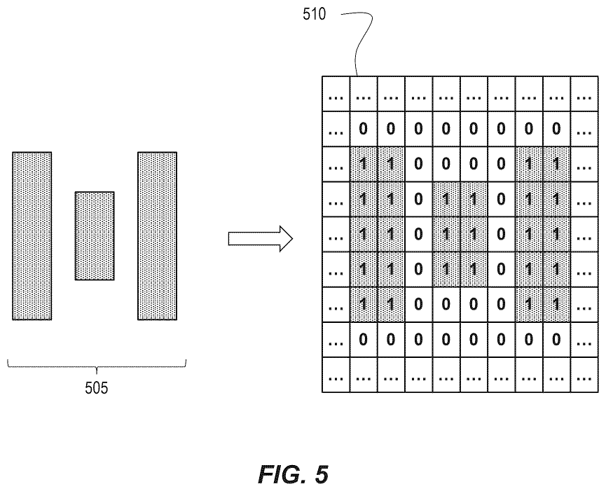

In step 120, the system converts each layout to a 2D image format. This conversion from electrical layout to an image representation prepares candidate layouts for subsequent machine learning processes. The conversion process involves rasterizing the geometric data of the layout (e.g., GDSII polygons) into a binary or grayscale image format. Each pixel in the image corresponds to a spatial region in the layout, encoding the presence or absence of design features such as metal layers, diffusion regions, or contacts. With the layout data converted to an image-based format, machine learning models trained for image-based analysis are incorporated herein and adapted for use in semiconductor design automation. Using image-based process of physical design can provide benefits not realized with conventional transistor-based analysis. This step can include using a first machine learning model that includes an encoder-decoder. FIG. 5 illustrates a representation of this technique. For example, GDS polygons 505 bounds data can be converted into binary image 510. This 2D representation can be sized based on netlist input, circuit size, efficiency criteria, or other considerations. In some embodiments, for example, a 64×64 binary image can be created. With design data converted into image format, machine learning models can be used that would otherwise not be beneficial or even considered for providing and evaluating electronic designs.

In step 122, the data is passed to an encoder to generate embeddings. These embeddings represent the layout in a compressed form that captures features for further analysis. The encoder is typically a convolutional neural network (CNN) or similar architecture that processes the image data to extract spatial and structural features. The output is a vector embedding that encodes layout characteristics such as symmetry, density, and connectivity patterns. The embeddings can create a representation of data as a vector in a lower-dimensional space, where similar data points are positioned close together, to capture underlying relationships and patterns between them. This allows a machine learning model to more easily process and understand complex data types, enabling improved physical design for circuits compared to conventional techniques.

In step 128, the system passes the embeddings to a decoder to generate input data. This step reconstructs the layout data from the embeddings, ensuring that the information is preserved and can be used for further evaluation. The decoder is a neural network that attempts to reconstruct the original layout image from the compressed embedding. This reconstruction is evaluated using a loss function that measures the fidelity of the output compared to the original input. A loss function 129 operation can then be used to check how far off target generated input data is. If there are errors or low accuracy then the first machine learning model (encompassing steps of 120, 122, and 128) can reprocess the input data.

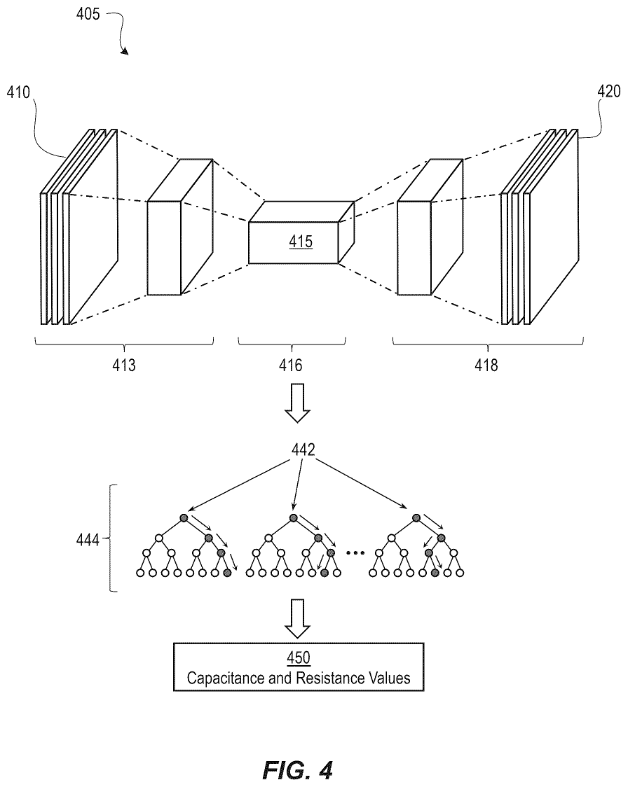

After generated embeddings are deemed satisfactory, after one or more evaluations using the first machine learning model, embeddings are transferred to or passed to a second machine learning model that evaluates the generated embeddings. The embeddings are received at the second model, in step 130. This second model is designed to perform regression analysis on the embeddings to predict physical parameters of the layout. These embeddings are then passed to a random forest regressor in step 135 to predict or extract the resistance and capacitance values of the corresponding layout. The random forest regressor is a supervised learning model that uses decision trees to estimate parasitic parameters based on layout features encoded in the embeddings. It is trained on labeled data where resistance and capacitance values are known for specific layouts. More detail can be found in the description for FIG. 4.

In step 138 the system extracts the corresponding resistance and capacitance values based on the predictions from the random forest regressor. These values are useful for evaluating the performance of the layout. A loss function 139 operation can be used to evaluate accuracy prior to continuing the process. This loss function compares predicted values with ground truth data obtained from simulation or measurement, and quantifies the prediction error. In step 140, the system obtains real capacitance values from SPX models. SPX models refer to simulation-based parasitic extraction tools that compute accurate capacitance values based on layout geometry and process parameters. The loss function 139 can also be used to measure the difference between the predicted and actual capacitance values. This iterative process continues until a particular layout meets the desired design rule constraints and performance metrics. The process and system described in FIG. 1 leverages machine learning and reinforcement learning techniques to automate the transistor layout design process, ensuring that the generated layouts are both electrically valid and optimized for performance.

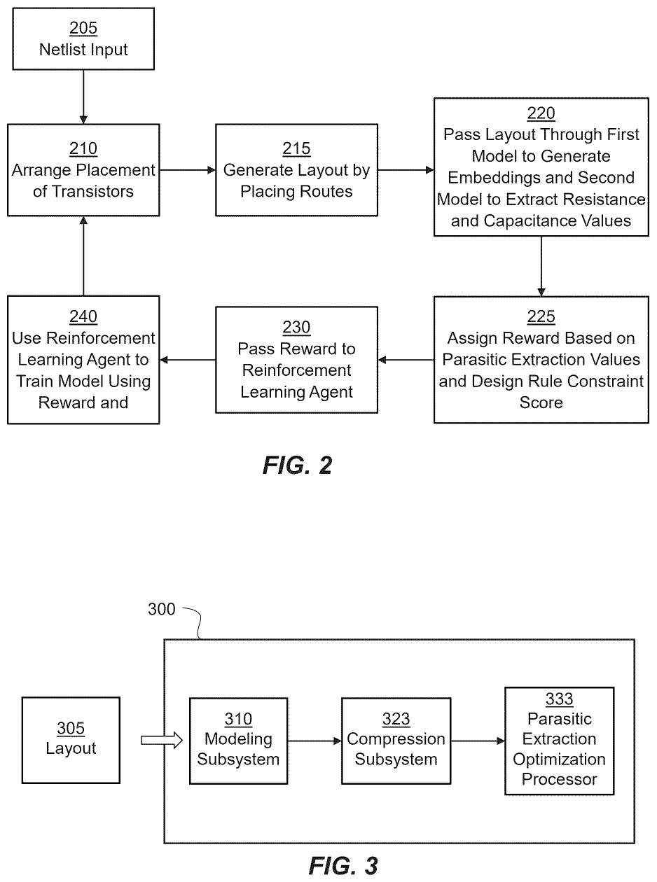

FIG. 2 shows a flow diagram of methods herein for reinforcement learning in layout design checking. The process begins with a netlist input 205, which includes a logical design of an integrated circuit, including descriptions of electronic components and their electrical connectivity. The netlist serves as the foundational input for the layout generation process, defining the functional relationships and connectivity between circuit elements such as transistors, resistors, and capacitors. It is preferably represented in a standardized format like Verilog or SPICE.

Step 210 involves arranging the placement of transistors based on the netlist input. In step 210, for example, the transistors can be positioned in a manner that adheres to initial netlist specifications, to provide candidate placements. This placement step uses heuristic or rule-based algorithms to map logical components to physical locations on the chip. Constraints such as proximity, symmetry, and timing-critical paths are considered to generate initial candidate layouts. The output is a spatial configuration of transistors that satisfies basic design intent.

In step 215, a layout is generated by placing routes. This step involves connecting the transistors and other components to form a complete and electrically valid layout. Routing algorithms are applied to establish physical interconnections between transistor terminals. These algorithms consider metal layer availability, via placement, congestion, and signal integrity. The result is a routed layout that is ready for evaluation. In step 220, the system passes the layout through a first model to generate embeddings and a second model to extract resistance and capacitance values. The first model is typically an encoder-decoder neural network that converts the layout into a compressed vector representation (embedding), capturing spatial and structural features. These embeddings are then evaluated by a second model, such as a random forest regressor or graph neural network, which predicts parasitic parameters like resistance and capacitance. The first model, typically an encoder-decoder, can generate embeddings for evaluation using a graph neural network or other machine learning model. The second model, which may include a random forest regressor, evaluates these embeddings to predict the resistance and capacitance values of the layout.

In step 225, after both the first model and the second model have been executed on the input, a reward is assigned based on the parasitic extraction values and a design rule constraint score. The parasitic extraction values reflect the electrical performance of the layout, while the design rule constraint score quantifies compliance with manufacturing and reliability rules (e.g., spacing, width, enclosure). These metrics are combined into a scalar reward signal that guides the learning process. The design rule constraint score indicates how closely the layout adheres to predetermined design rules. The reward reflects the quality of the layout in terms of electrical performance and compliance with design rules.

In step 230, the system passes the reward to a reinforcement learning agent. The reinforcement learning (RL) agent uses this reward to update its policy, which governs how it selects actions such as transistor placement and routing strategies. The agent may use algorithms like Proximal Policy Optimization (PPO) or Deep Q-Networks (DQN) to learn from the reward feedback. The reinforcement learning agent uses this reward to adjust the permutation generator and improve the layout generation process.

In Step 240, the reinforcement learning agent is used to train the model using the reward. This training involves multiple iterations where the RL agent explores different layout configurations, receives rewards, and updates its policy to maximize long-term performance. The agent gradually learns to generate layouts that are both electrically efficient and design-rule compliant. This step involves iteratively refining the layout generation process to produce layouts that better meet design specifications and performance metrics. This approach enables generated layouts to be both electrically valid and optimized for performance.

FIG. 3 is a simplified schematic showing embodiments using a subsystem 300 (or other subsystem of a larger system). The compression subsystem 323 and its associated processors can be an improved computing subsystem and/or algorithm that performs data reduction, feature selection, or simplification of layout or parasitic extraction data, so that the parasitic capacitance optimization processor 333 has less data to process. The speed improvement arises because the compression subsystem 323 reduces input dimensionality, filters less relevant features, or limits the amount of data passed on, thereby reducing computational load, memory usage, and possibly also reducing model inference time.

The compression subsystem 323 receives input from modeling subsystem 310, which generates or proposes candidate physical layouts or logical layouts; these layouts may come from layout design tools, netlist-to-placement/placement-to-layout steps, or from user inputs. The layout input is denoted layout 305, which contains geometric layout information (layers, shapes, widths, spacings), connectivity (nets), design rules, and optionally process or material metadata.

Within subsystem 300, modeling subsystem 310 may also simulate or approximate parasitic effects or generate features useful for downstream modules. For example, modeling subsystem 310 may compute or extract preliminary features such as net lengths, metal widths, spacing, layer thickness, via count, overlap regions, and adjacency (nearby conductors) information. These features become candidates for compression. Some embodiments may integrate subsystem 300 as part of a larger system that includes layout generation, transistor ordering, PPAC (Performance-Power-Area-Cost) optimization, and final parasitic extraction. In such a system, subsystem 300 acts as an upstream filter, reducing the computational burden on downstream modules, enabling faster iteration cycles in the design verification flow.

FIG. 4 shows a system architecture that uses two models to generate a layout and to check the physical layout. The architecture includes an autoencoder 405, which processes an input GDS 410 through an encoder 413. The input GDS 410 refers to a layout file in GDSII format, which contains geometric representations of circuit components and interconnects. The encoder 413 is typically a convolutional neural network (CNN) or similar architecture that transforms the GDS layout into a compressed latent representation. This is used to generate a latent space representation model 415. The latent space representation model 415 captures essential layout features such as spatial relationships, density, and symmetry in a reduced-dimensional format. This representation is suitable for downstream tasks like layout evaluation and optimization. Note, however, that in conventional processes, this architecture would create bottleneck 416, prior to moving the process to a decoder 418 to produce an output GDS 420. The bottleneck 416 refers to the dimensional constraint imposed by the latent space, which limits the amount of information retained during encoding. The decoder 418 reconstructs the layout from the latent representation, aiming to preserve fidelity and structural integrity. The output GDS 420 is a regenerated layout file that can be used for further analysis or fabrication.

Accordingly, data from the latent space representation model 415 can be sent to a parasitic extraction model 442, that implements a set of random forest trees 444 for evaluation. The parasitic extraction model 442 is designed to predict electrical characteristics of the layout, such as resistance and capacitance, using machine learning techniques. The random forest trees 444 are an ensemble of decision trees trained on labeled layout data to estimate parasitic parameters based on geometric and topological features extracted from the latent space.

The random forest trees 444 analyze the layout data to predict or extract capacitance and resistance values. Each tree in the forest contributes to the prediction, and the final output is an average or weighted combination of individual tree predictions, improving robustness and accuracy. The parasitic extraction model 442 evaluates the layout's electrical properties, and the random forest trees 444 aggregate these evaluations to generate final capacitance and resistance values 450. These resistance values 450 are critical for assessing signal integrity, timing, and power consumption in the circuit, and are used to validate whether the layout meets performance specifications.

This architecture leverages the autoencoder 405 to efficiently compress and reconstruct layout data, while the parasitic extraction model 442 and random forest trees 444 provide accurate predictions of the layout's electrical characteristics. The integration of deep learning (autoencoder) and ensemble learning (random forest) enables a hybrid approach that combines spatial feature extraction with statistical prediction. This allows for scalable and efficient evaluation of complex layouts.

The combination of these models ensures that the generated layouts are both physically valid and optimized or improved for performance and more efficient generation. By automating layout evaluation and optimization, this system architecture supports faster design cycles and improved design quality in semiconductor physical design workflows.

FIG. 5 is a conceptual representation of conversion techniques used in layout design checking. The figure illustrates how geometric layout data, such as GDS polygons 505, can be transformed into a binary image format suitable for machine learning analysis. The GDS polygons 505 represent physical layout features such as metal layers, diffusion regions, and contacts. These are typically defined in a GDSII file format, which encodes the spatial geometry of integrated circuit components. Each polygon corresponds to a specific layer or design element in the layout.

The conversion process involves rasterizing the GDS polygon data into a structured binary image. This rasterization step maps the geometric coordinates of the polygons onto a fixed-size grid, where each cell (or pixel) in the grid is assigned a binary value, typically ‘1’ if the polygon occupies that region and ‘0’ otherwise. The resulting binary image 510 captures the spatial distribution of layout features in a format compatible with image-based machine learning models. This binary image can be of a predefined resolution, such as 64×64 or 128×128 pixels, depending on the size and complexity of the layout. The resolution may be selected based on trade-offs between computational efficiency and feature fidelity.

This conversion technique enables the use of convolutional neural networks (CNNs) and other image-based models for layout evaluation and optimization.

By representing layout data as images, the system can leverage well-established computer vision techniques to extract features, detect patterns, and classify design elements. This approach allows for scalable and automated analysis of physical layouts, which is difficult to achieve using traditional rule-based methods. The binary image format also facilitates embedding generation, where the image is passed through an encoder to produce a latent vector representation that captures the essential characteristics of the layout.

The transformation from GDS polygons to binary images, as shown in FIG. 5, is a foundational step in enabling machine learning-driven physical design automation.

It bridges the gap between geometric layout data and data-driven modeling techniques, allowing for improved layout quality, faster design cycles, and enhanced predictive capabilities. This conceptual representation provides sufficient detail for a person of ordinary skill in the art to implement similar conversion techniques, with the understanding that some experimentation may be required to optimize resolution, encoding schemes, and model architectures.

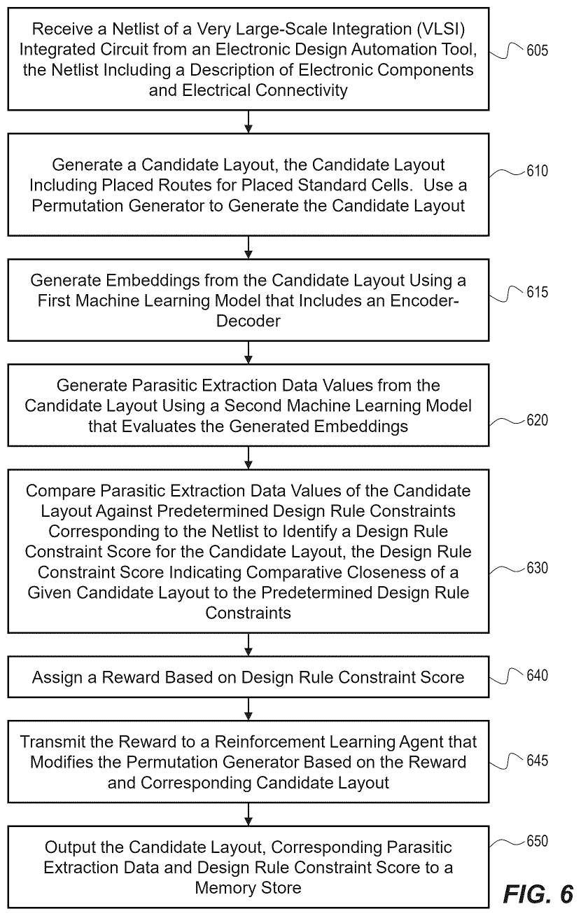

Referring now to FIG. 6, a flow chart illustrates processes for automating semiconductor design. In step 605, the system initiates the process by receiving a netlist of a very large-scale integration (VLSI) integrated circuit from an electronic design automation tool. The netlist, or other format for logical design, can include a description of electronic components and electrical connectivity. There are existing electronic design automation tools or software programs that can generate a particular netlist.

In step 610, the system generates a candidate layout from the netlist. The candidate layout includes placed routes for placed standard cells. A permutation generator can be used to generate the candidate layout. This step enables the layout to adhere to the initial netlist specifications to be ready for further evaluation. At this initial stage, candidate layouts can be held in working memory or temporary database.

In step 615, the system generates embeddings from the candidate layout using a first machine learning model that includes an encoder-decoder. The embeddings represent or model the layout in a form that captures features for further analysis in computerized models. This step is beneficial for transforming the layout data into a format suitable for improved machine learning processes. In some embodiments, the first machine learning model can be a convolutional neural network (CNN). For example, a feed-forward neural network that learns features by itself via filter optimization. This type of deep learning network is primarily used for image recognition and processing, but is adapted herein to be applied to electronic design automation to improve physical design efficiency and rule checking.

In step 620, the system generates parasitic extraction data values from the candidate layout using a second machine learning model that evaluates the generated embeddings. This step involves using the second machine learning model to predict the resistance and capacitance values of the layout. The parasitic extraction data values are used for evaluating the performance of the layout and improving electronic design.

In step 630, the system compares parasitic extraction data values of the candidate layout against predetermined design rule constraints corresponding to the netlist. This step identifies a design rule constraint score for the candidate layout. The design rule constraint score indicates the comparative closeness of a given candidate layout to the predetermined design rule constraints.

In step 640, the system assigns a reward based on the design rule constraint score. The reward reflects the quality of the layout in terms of electrical performance and compliance with design rules. This step guides the reinforcement learning agent in improving the layout generation process.

In step 645, the system transmits the reward to a reinforcement learning agent that modifies the permutation generator based on the reward and corresponding candidate layout. This step ensures that the reinforcement learning agent can adjust the permutation generator in real-time based on immediate rewards, leading to continuous improvement in the layout generation process, thereby producing improved physical designs. In step 650, the system can output the candidate layout as a GDS file, corresponding parasitic extraction data, and design rule constraint score to a memory store. The GDS file contains information about placed routes, such as where metal polygons are placed and routed to connect with each other. Thus, once design rule constraints are checked, a final output can be a GDS file. Parasitics extraction data is stored separately where each layout polygons resistance and capacitance value with respect to input netlist can be stored in a SPICE format (Simulation Program with Integrated Circuit Emphasis), and/or annotated netlist. The DRC score is stored separately, such as in XML files.

In alternative embodiments, example architectures disclosed herein can use a simulated annealing algorithm and a machine learning-based resistance-capacitance value network as explained above. The simulated annealing algorithm is configured to perform device pairing and placement concurrently as actions in the reinforcement learning environment. The agent herein uses machine learning to evaluate the likelihood that a given placement can generate a layout and that reward for that layout is given by the machine learning model, improving the quality and PPAC of the generated layouts. This combination allows the architecture to produce layouts with desired resistance capacitance values

In other example embodiments, a semiconductor-manufacturing system herein further comprises a reinforcement learning (RL) engine for automating standard cell layout design. The system's RL-based approach handles design rule violations during routing. A routing problem can be decomposed into initial routing and DRC fixing, with a PPAC-based reward correction. The reinforcement learning agent is trained to effectively resolve DRC issues incrementally. Embodiments also include converting a candidate layout into a 2D image format for processing.

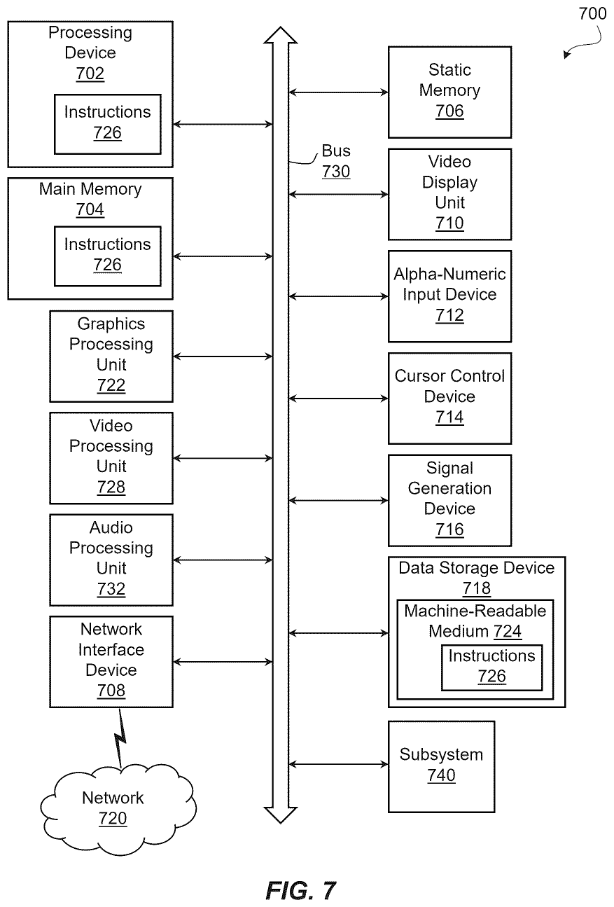

In other embodiments, the system can include receiving the netlist as an input of a modeling subsystem coupled to the electronic design automation tool. And then identifying transistors from the netlist, creating the graph neural network, generating the node embeddings, and ordering the node embeddings can all be executed by a compression subsystem that includes one or more processors. A parasitic capacitance optimization processor coupled to the compression subsystem can be used to perform the parasitic extraction and generating the placement order. These subsystems can be incorporated into Subsystem 740 of FIG. 7.

FIG. 7 depicts a representative diagram of an example computer system in which embodiments of the present disclosure may operate.

A storage subsystem of a computer system (such as computer system 700 of FIG. 7) may be used to store the programs and data structures that are used by some or all of the EDA products described herein, and products used for development of cells for the library and for physical and logical design that use the library.

FIG. 7 illustrates an example machine of a computer system 700 within which a set of instructions, for causing the machine to perform any one or more of the methodologies discussed herein, including transistor design rule checking using reinforcement learning, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM), a static memory 706 (e.g., flash memory, static random access memory (SRAM), etc.), and a data storage device 718, which communicate with each other via a bus 730.

Processing device 702 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 may be configured to execute instructions 726 for performing the operations and steps described herein.

The computer system 700 may further include a network interface device 708 to communicate over the network 720. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), a graphics processing unit 722, a signal generation device 716 (e.g., a speaker), graphics processing unit 722, video processing unit 728, and audio processing unit 732.

The data storage device 718 may include a machine-readable storage medium 724 (also known as a non-transitory computer-readable medium) on which is stored one or more sets of instructions 726 or software embodying any one or more of the methodologies or functions described herein. The instructions 726 may also reside, completely or at least partially, within the main memory 704 and/or within the processing device 702 during execution thereof by the computer system 700, the main memory 704 and the processing device 702 also constituting machine-readable storage media.

In some implementations, the instructions 726 include instructions to implement functionality corresponding to the present disclosure. While the machine-readable storage medium 724 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 702 to perform any one or more of the methodologies of the present disclosure. The term “machine-readable storage medium” shall accordingly be taken to include, but not be limited to, solid-state memories, optical media, and magnetic media.

Some portions of the preceding detailed description have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be noted, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

1. A method for automating semiconductor design, the method comprising:
receiving a netlist of a very large-scale integration (VLSI) integrated circuit from an electronic design automation tool, the netlist including a description of electronic components and electrical connectivity;
generating, by a processing device, a candidate layout, the candidate layout including placed routes for placed standard cells, wherein a permutation generator is used to generate the candidate layout;
generating, by the processing device, embeddings from the candidate layout using a first machine learning model that includes an encoder-decoder;
generating, by the processing device, parasitic extraction data values from the candidate layout using a second machine learning model that evaluates the generated embeddings;
comparing parasitic extraction data values of the candidate layout against predetermined design rule constraints corresponding to the netlist to identify a design rule constraint score for the candidate layout, the design rule constraint score indicating comparative closeness of a given candidate layout to the predetermined design rule constraints;
assigning a reward based on the design rule constraint score;
transmitting, by the processing device, the reward to a reinforcement learning agent that modifies the permutation generator based on the reward and corresponding candidate layout; and
outputting, by the processing device, the candidate layout as a graphic design system file (GDS file), corresponding parasitic extraction data, and corresponding design rule constraint score to a memory store.

2. The method of claim 1, further comprising:
using the permutation generator to generate a modified candidate layout subsequent to receiving the reward assigned;
generating, by the processing device, embeddings from the modified candidate layout using the first machine learning model;
generating, by the processing device, parasitic extraction data values from the modified candidate layout using the second machine learning model;
comparing parasitic extraction data values of the modified candidate layout against predetermined design rule constraints corresponding to the netlist to identify a second design rule constraint score for the modified candidate layout;
assigning a second reward based on the design rule constraint score; and
repeating steps of evaluating candidate layouts until a predetermined design rule constraint score is achieved.

3. The method of claim 2, wherein generating, by the processing device, parasitic extraction data values from the candidate layout using the second machine learning model includes evaluating embeddings using a random forest regressor to generate parasitic extraction data.

4. The method of claim 1, further comprising:
converting the candidate layout into a two-dimensional image layout of a predetermined size prior to generating embeddings from the candidate layout using the first machine learning model.

5. The method of claim 4, wherein converting the candidate layout into the two-dimensional image layout includes rasterizing geometric data of the layout into a binary image format.

6. The method of claim 1, further comprising:
identifying one or more design rule violations of the candidate layout;
requesting a modified candidate layout from the permutation generator in response to identifying the one or more design rule violations; and
iterating through steps of generating embeddings using the first machine learning model, generating parasitic extraction data values using the second machine learning model, and comparing parasitic extraction data values against predetermined design rule constraints corresponding to the netlist to identify the design rule constraint score until a given modified candidate layout is identified without design rule violations.

7. The method of claim 6, further comprising:
using the reinforcement learning agent to train the permutation generator based on identified design rule violations.

8. The method of claim 7, wherein the reward assigned corresponds to one or more of a power metric, performance metric, area metric, and cost metric.

9. A system comprising:
a memory storing instructions; and
a processing device, coupled with the memory and configured to execute the instructions, the instructions when executed cause the processing device to:
receive a netlist of a very large-scale integration (VLSI) integrated circuit from an electronic design automation tool, the netlist including a description of electronic components and electrical connectivity;
generate a candidate layout, the candidate layout including placed routes for placed standard cells, wherein a permutation generator is used to generate the candidate layout;
generate embeddings from the candidate layout using a first machine learning model that includes an encoder-decoder;
generate parasitic extraction data values from the candidate layout using a second machine learning model that evaluates the generated embeddings;
compare parasitic extraction data values of the candidate layout against predetermined design rule constraints corresponding to the netlist to identify a design rule constraint score for the candidate layout, the design rule constraint score indicating comparative closeness of a given candidate layout to the predetermined design rule constraints;
assign a reward based on design rule constraint score;
transmit the reward to a reinforcement learning agent that modifies the permutation generator based on the reward and corresponding candidate layout; and
output the candidate layout as a graphic design system file (GDS file), corresponding parasitic extraction data, and design rule constraint score to a memory store.

10. The system of claim 9, wherein the instructions further cause the processing device to:
use the permutation generator to generate a modified candidate layout subsequent to receiving the reward assigned;
generate embeddings from the modified candidate layout using the first machine learning model;
generate parasitic extraction data values from the modified candidate layout using the second machine learning model;
compare parasitic extraction data values of the modified candidate layout against predetermined design rule constraints corresponding to the netlist to identify a second design rule constraint score for the modified candidate layout;
assign a second reward based on the design rule constraint score; and
repeat steps of evaluating candidate layouts until a predetermined design rule constraint score is achieved.

11. The system of claim 10, wherein generating parasitic extraction data values from the candidate layout using the second machine learning model includes evaluating embeddings using a random forest regressor to generate parasitic extraction data.

12. The system of claim 11, wherein the instructions further cause the processing device to:
convert the candidate layout into a two-dimensional image layout of a predetermined size prior to generating embeddings from the candidate layout using the first machine learning model.

13. The system of claim 9, wherein the instructions further cause the processing device to:
identify one or more design rule violations of the candidate layout;
request a modified candidate layout from the permutation generator in response to identifying the one or more design rule violations; and
iterate through instructions to generate embeddings using the first machine learning model, generate parasitic extraction data values using the second machine learning model, and compare parasitic extraction data values against predetermined design rule constraints corresponding to the netlist to identify the design rule constraint score until a given modified candidate layout is identified without design rule violations.

14. The system of claim 13, wherein the instructions further cause the processing device to:
use the reinforcement learning agent to train the permutation generator based on identified design rule violations.

15. The system of claim 14, wherein the reward assigned corresponds to one or more of a power metric, performance metric, area metric, and cost metric.

16. A non-transitory computer readable medium comprising stored instructions, which when executed by a processing device, cause the processing device to:
receive a netlist of a very large-scale integration (VLSI) integrated circuit from an electronic design automation tool, the netlist including a description of electronic components and electrical connectivity;
generate a candidate layout, the candidate layout including placed routes for placed standard cells, wherein a permutation generator is used to generate the candidate layout;
generate embeddings from the candidate layout using a first machine learning model that includes an encoder-decoder;
generate parasitic extraction data values from the candidate layout using a second machine learning model that evaluates the generated embeddings;
compare parasitic extraction data values of the candidate layout against predetermined design rule constraints corresponding to the netlist to identify a design rule constraint score for the candidate layout, the design rule constraint score indicating comparative closeness of a given candidate layout to the predetermined design rule constraints;
assign a reward based on design rule constraint score;
transmit the reward to a reinforcement learning agent that modifies the permutation generator based on the reward and corresponding candidate layout; and
output the candidate layout as a graphic design system file (GDS file), corresponding parasitic extraction data, and design rule constraint score to a memory store.

17. The non-transitory computer readable medium of claim 16, wherein the instructions further cause the processing device to:
use the permutation generator to generate a modified candidate layout subsequent to receiving the reward assigned;
generate embeddings from the modified candidate layout using the first machine learning model;
generate parasitic extraction data values from the modified candidate layout using the second machine learning model;
compare parasitic extraction data values of the modified candidate layout against predetermined design rule constraints corresponding to the netlist to identify a second design rule constraint score for the modified candidate layout;
assign a second reward based on the design rule constraint score; and
repeat steps of evaluating candidate layouts until a predetermined design rule constraint score is achieved.

18. The non-transitory computer readable medium of claim 17, wherein generating parasitic extraction data values from the candidate layout using the second machine learning model includes evaluating embeddings using a random forest regressor to generate parasitic extraction data.

19. The non-transitory computer readable medium of claim 18, wherein the instructions further cause the processing device to:
convert the candidate layout into a two-dimensional image layout of a predetermined size prior to generating embeddings from the candidate layout using the first machine learning model.

20. The non-transitory computer readable medium of claim 19, wherein the instructions further cause the processing device to:
identify one or more design rule violations of the candidate layout;
request a modified candidate layout from the permutation generator in response to identifying the one or more design rule violations;
iterate through instructions to generate embeddings using the first machine learning model, generate parasitic extraction data values using the second machine learning model, and compare parasitic extraction data values against predetermined design rule constraints corresponding to the netlist to identify the design rule constraint score until a given modified candidate layout is identified without design rule; and
use the reinforcement learning agent to train the permutation generator based on identified design rule violations.
